(19) United States
(12) Patent Application Publication
(10) Pub. No.: US 2025/0013475 A1
(43) Pub. Date: Jan. 9, 2025

(54) METHOD AND SYSTEM FOR PROVIDING AN INTELLIGENT END-TO-END USER INTERFACE PLATFORM

(71) Applicant: JPMorgan Chase Bank, N.A., New York, NY (US)

(72) Inventors: Abhirup BISWAS, Glasgow (GB); Yingzhao ZHOU, Hampshire (GB)

(73) Assignee: JPMorgan Chase Bank, N.A., New York, NY (US)

(21) Appl. No.: 18/217,756

(22) Filed: Jul. 3, 2023

(51) Int. Cl. G06F 9/451; G06F 3/04842; G06F 3/0486

(52) U.S. Cl. CPC G06F 9/451; G06F 3/04842; G06F 3/0486

(57) ABSTRACT

A method for providing an intelligent end-to-end platform to facilitate dynamic user interface configuration is disclosed. The method includes automatically generating core layouts based on a predetermined platform structure, each of the core layouts corresponding to an executable microapp; persisting the core layouts in a core repository; displaying, via a graphical user interface, a graphical element that is configured to receive inputs; receiving, via the graphical user interface, a request to generate a user interface, the request including a selection of a rule, a business logic, and a service; identifying, based on the request, a matching core layout from the core layouts in the core repository; and automatically generating the user interface by using the matching core layout and the request.

### BACKGROUND

### 1. Field of the Disclosure

This technology generally relates to methods and systems for user interface management, and more particularly to methods and systems for providing an intelligent end-to-end platform to facilitate dynamic user interface configuration and customizable data storage.

### 2. Background Information

Many lines of businesses within an entity rely on user interface solutions to facilitate business operations and provide services for users. Often, each of these lines of businesses are tasked with creating their own user interface solutions. Historically, implementations of conventional user interface management platforms have resulted in varying degrees of success with respect to creating a robust and easily configurable framework for each processing layer to allow for tailored user interface solutions.

One drawback of using the conventional user interface management platforms is that in many instances, considerable user interface knowledge and resource investments are required from each of the lines of business to generate and maintain the tailored user interface solutions. As a result, the lines of business tend to stick with a current working version instead even when the current working version is outdated. Additionally, due to user interface technologies rapidly changing, maintaining outdated working versions may lead to operating inefficiencies and system vulnerabilities.

Therefore, there is a need for an intelligent end-to-end platform to facilitate dynamic user interface configuration and customizable data storage by implementing modelized solution, simplified storage, and visualization requirements segregation.

### SUMMARY

The present disclosure, through one or more of its various aspects, embodiments, and/or specific features or sub-components, provides, inter alia, various systems, servers, devices, methods, media, programs, and platforms for providing an intelligent end-to-end platform to facilitate dynamic user interface configuration and customizable data storage.

According to an aspect of the present disclosure, a method for providing an intelligent end-to-end platform to facilitate dynamic user interface configuration is disclosed. The method is implemented by at least one processor. The method may include automatically generating a plurality of core layouts based on a predetermined platform structure, each of the plurality of core layouts may correspond to an executable microapp; persisting the plurality of core layouts in a core repository; displaying, via a graphical user interface, at least one graphical element that is configured to receive at least one input; receiving, via the graphical user interface, a request to generate at least one user interface, the request may include a selection of at least one from among a rule, a business logic, and a service; identifying, based on the request, at least one matching core layout from the plurality of core layouts in the core repository; and automatically generating the at least one user interface by using the at least one matching core layout and the request.

In accordance with an exemplary embodiment, the method may further include aggregating configuration data that correspond to the at least one user interface, the configuration data may include information that relates to at least one from among the request, the at least one matching core layout, and the at least one user interface; associating the configuration data with a line of business by using identifying data that is extracted from the request; and persisting the configuration data and the association in a historical configuration database.

In accordance with an exemplary embodiment, the method may further include determining, by using at least one model, at least one suggested configuration for the line of business based on the corresponding configuration data in the historical configuration database; and displaying, via the graphical user interface, the at least one suggested configuration in the at least one graphical element for the line of business.

In accordance with an exemplary embodiment, the at least one model may include at least one from among a machine learning model, a mathematical model, a process model, and a data model.

In accordance with an exemplary embodiment, to automatically generate the plurality of core layouts, the method may further include identifying at least one code library that corresponds to the predetermined platform structure; identifying at least one interaction that corresponds to the predetermined platform structure; identifying at least one dependency that corresponds to the predetermined platform structure; and automatically generating each of the plurality of core layouts based on the at least one code library, the at least one interaction, and the at least one dependency.

In accordance with an exemplary embodiment, to receive the request, the method may further include receiving, via the graphical user interface, at least one user action that corresponds to the selection, wherein the at least one user action may include a drag and drop action to select at least one from among the rule, the business logic, and the service.

In accordance with an exemplary embodiment, to automatically generate the at least one user interface, the method may further include extracting at least one configuration from the request, the at least one configuration may correspond to the at least one user interface; generating a configuration component for each of the at least one matching core layout based on the extracted at least one configuration; and automatically generating the at least one user interface by combining the at least one matching core layout with the corresponding configuration component.

In accordance with an exemplary embodiment, the method may further include capturing, via the automatically generated at least one user interface, user profile data and corresponding search history data; determining, by using at least one model, at least one predicted data set for a user based on the user profile data and the corresponding search history data; and preloading the at least one predicted data set in a temporary quick access repository for the user.

In accordance with an exemplary embodiment, the method may further include automatically archiving, by using the at least one model, the at least one predicted data set based on the user profile data and the corresponding search history data, wherein the at least one predicted data set may be automatically archived at a time determined by using the at least one model.

According to an aspect of the present disclosure, a computing device configured to implement an execution of a method for providing an intelligent end-to-end platform to facilitate dynamic user interface configuration is disclosed. The computing device including a processor; a memory; and a communication interface coupled to each of the processor and the memory, wherein the processor may be configured to automatically generate a plurality of core layouts based on a predetermined platform structure, each of the plurality of core layouts may correspond to an executable microapp; persist the plurality of core layouts in a core repository; display, via a graphical user interface, at least one graphical element that is configured to receive at least one input; receive, via the graphical user interface, a request to generate at least one user interface, the request may include a selection of at least one from among a rule, a business logic, and a service; identify, based on the request, at least one matching core layout from the plurality of core layouts in the core repository; and automatically generate the at least one user interface by using the at least one matching core layout and the request.

In accordance with an exemplary embodiment, the processor may be further configured to aggregate configuration data that correspond to the at least one user interface, the configuration data may include information that relates to at least one from among the request, the at least one matching core layout, and the at least one user interface; associate the configuration data with a line of business by using identifying data that is extracted from the request; and persist the configuration data and the association in a historical configuration database.

In accordance with an exemplary embodiment, the processor may be further configured to determine, by using at least one model, at least one suggested configuration for the line of business based on the corresponding configuration data in the historical configuration database; and display, via the graphical user interface, the at least one suggested configuration in the at least one graphical element for the line of business.

In accordance with an exemplary embodiment, the at least one model may include at least one from among a machine learning model, a mathematical model, a process model, and a data model.

In accordance with an exemplary embodiment, to automatically generate the plurality of core layouts, the processor may be further configured to identify at least one code library that corresponds to the predetermined platform structure; identify at least one interaction that corresponds to the predetermined platform structure; identify at least one dependency that corresponds to the predetermined platform structure; and automatically generate each of the plurality of core layouts based on the at least one code library, the at least one interaction, and the at least one dependency.

In accordance with an exemplary embodiment, to receive the request, the processor may be further configured to receive, via the graphical user interface, at least one user action that corresponds to the selection, wherein the at least one user action may include a drag and drop action to select at least one from among the rule, the business logic, and the service.

In accordance with an exemplary embodiment, to automatically generate the at least one user interface, the processor may be further configured to extract at least one configuration from the request, the at least one configuration may correspond to the at least one user interface; generate a configuration component for each of the at least one matching core layout based on the extracted at least one configuration; and automatically generate the at least one user interface by combining the at least one matching core layout with the corresponding configuration component.

In accordance with an exemplary embodiment, the processor may be further configured to capture, via the automatically generated at least one user interface, user profile data and corresponding search history data; determine, by using at least one model, at least one predicted data set for a user based on the user profile data and the corresponding search history data; and preload the at least one predicted data set in a temporary quick access repository for the user.

In accordance with an exemplary embodiment, the processor may be further configured to automatically archive, by using the at least one model, the at least one predicted data set based on the user profile data and the corresponding search history data, wherein the at least one predicted data set may be automatically archived at a time determined by using the at least one model.

According to an aspect of the present disclosure, a non-transitory computer readable storage medium storing instructions for providing an intelligent end-to-end platform to facilitate dynamic user interface configuration is disclosed. The storage medium including executable code which, when executed by a processor, may cause the processor to automatically generate a plurality of core layouts based on a predetermined platform structure, each of the plurality of core layouts may correspond to an executable microapp; persist the plurality of core layouts in a core repository; display, via a graphical user interface, at least one graphical element that is configured to receive at least one input; receive, via the graphical user interface, a request to generate at least one user interface, the request may include a selection of at least one from among a rule, a business logic, and a service; identify, based on the request, at least one matching core layout from the plurality of core layouts in the core repository; and automatically generate the at least one user interface by using the at least one matching core layout and the request.

In accordance with an exemplary embodiment, when executed by the processor, the executable code may further cause the processor to aggregate configuration data that correspond to the at least one user interface, the configuration data may include information that relates to at least one from among the request, the at least one matching core layout, and the at least one user interface; associate the configuration data with a line of business by using identifying data that is extracted from the request; and persist the configuration data and the association in a historical configuration database.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing an intelligent end-to-end platform to facilitate dynamic user interface configuration and customizable data storage.

FIG. 4 is a flowchart of an exemplary process for implementing a method for providing an intelligent end-to-end platform to facilitate dynamic user interface configuration and customizable data storage.

FIG. 5 is a flow diagram of an exemplary process for implementing a method for providing an intelligent end-to-end platform to facilitate dynamic user interface configuration and customizable data storage.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

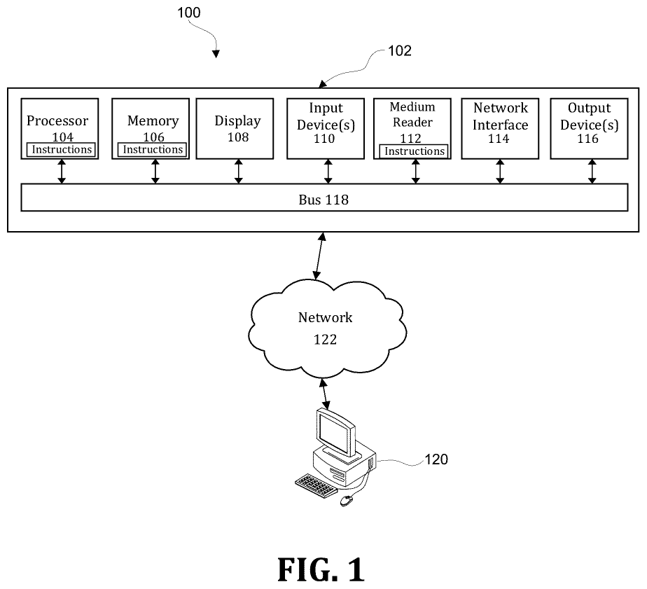

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons skilled in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing an intelligent end-to-end platform to facilitate dynamic user interface configuration and customizable data storage.

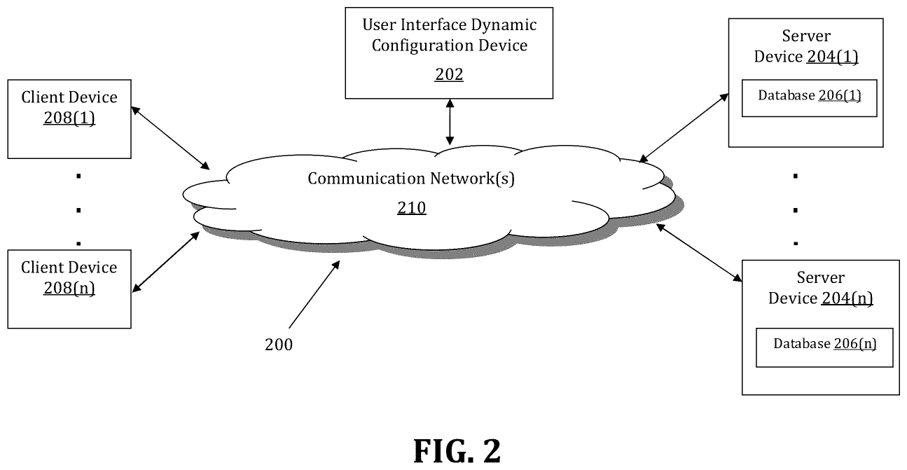

Referring to FIG. 2, a schematic of an exemplary network environment 200 for implementing a method for providing an intelligent end-to-end platform to facilitate dynamic user interface configuration and customizable data storage is illustrated. In an exemplary embodiment, the method is executable on any networked computer platform, such as, for example, a personal computer (PC).

The method for providing an intelligent end-to-end platform to facilitate dynamic user interface configuration and customizable data storage may be implemented by a User Interface Dynamic Configuration (UIDC) device 202. The UIDC device 202 may be the same or similar to the computer system 102 as described with respect to FIG. 1. The UIDC device 202 may store one or more applications that can include executable instructions that, when executed by the UIDC device 202, cause the UIDC device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the UIDC device 202 itself, may be located in virtual server(s) running in a cloud-based computing environment rather than being tied to one or more specific physical network computing devices. Also, the application(s) may be running in one or more virtual machines (VMs) executing on the UIDC device 202. Additionally, in one or more embodiments of this technology, virtual machine(s) running on the UIDC device 202 may be managed or supervised by a hypervisor.

In the network environment 200 of FIG. 2, the UIDC device 202 is coupled to a plurality of server devices 204(1)-204(n) that hosts a plurality of databases 206(1)-206 (n), and also to a plurality of client devices 208(1)-208(n) via communication network(s) 210. A communication interface of the UIDC device 202, such as the network interface 114 of the computer system 102 of FIG. 1, operatively couples and communicates between the UIDC device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the UIDC device 202, the server devices 204(1)-204 (n), and/or the client devices 208(1)-208 (n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and UIDC devices that efficiently implement a method for providing an intelligent end-to-end platform to facilitate dynamic user interface configuration and customizable data storage.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The UIDC device 202 may be a standalone device or integrated with one or more other devices or apparatuses, such as one or more of the server devices 204(1)-204 (n), for example. In one particular example, the UIDC device 202 may include or be hosted by one of the server devices 204(1)-204 (n), and other arrangements are also possible. Moreover, one or more of the devices of the UIDC device 202 may be in a same or a different communication network including one or more public, private, or cloud networks, for example.

The plurality of server devices 204(1)-204 (n) may be the same or similar to the computer system 102 or the computer device 120 as described with respect to FIG. 1, including any features or combination of features described with respect thereto. For example, any of the server devices 204(1)-204 (n) may include, among other features, one or more processors, a memory, and a communication interface, which are coupled together by a bus or other communication link, although other numbers and/or types of network devices may be used. The server devices 204(1)-204 (n) in this example may process requests received from the UIDC device 202 via the communication network(s) 210 according to the HTTP-based and/or JavaScript Object Notation (JSON) protocol, for example, although other protocols may also be used.

The server devices 204(1)-204 (n) may be hardware or software or may represent a system with multiple servers in a pool, which may include internal or external networks. The server devices 204(1)-204 (n) hosts the databases 206(1)-206 (n) that are configured to store data that relates to core layouts, platform structures, microapps, graphical elements, inputs, requests, selections, configuration data, suggested configurations, profile data, and search history data.

Although the server devices 204(1)-204 (n) are illustrated as single devices, one or more actions of each of the server devices 204(1)-204 (n) may be distributed across one or more distinct network computing devices that together comprise one or more of the server devices 204(1)-204 (n). Moreover, the server devices 204(1)-204 (n) are not limited to a particular configuration. Thus, the server devices 204(1)-204 (n) may contain a plurality of network computing devices that operate using a controller/agent approach, whereby one of the network computing devices of the server devices 204(1)-204 (n) operates to manage and/or otherwise coordinate operations of the other network computing devices.

The server devices 204(1)-204 (n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208 (n) may also be the same or similar to the computer system 102 or the computer device 120 as described with respect to FIG. 1, including any features or combination of features described with respect thereto. For example, the client devices 208(1)-208 (n) in this example may include any type of computing device that can interact with the UIDC device 202 via communication network(s) 210. Accordingly, the client devices 208(1)-208 (n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208 (n) may run interface applications, such as standard web browsers or standalone client applications, which may provide an interface to communicate with the UIDC device 202 via the communication network(s) 210 in order to communicate user requests and information. The client devices 208(1)-208 (n) may further include, among other features, a display device, such as a display screen or touchscreen, and/or an input device, such as a keyboard, for example.

Although the exemplary network environment 200 with the UIDC device 202, the server devices 204(1)-204 (n), the client devices 208(1)-208 (n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the UIDC device 202, the server devices 204(1)-204 (n), or the client devices 208(1)-208 (n), for example, may be configured to operate as virtual instances on the same physical machine. In other words, one or more of the UIDC device 202, the server devices 204(1)-204 (n), or the client devices 208(1)-208 (n) may operate on the same physical device rather than as separate devices communicating through communication network(s) 210. Additionally, there may be more or fewer UIDC devices 202, server devices 204(1)-204 (n), or client devices 208(1)-208 (n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

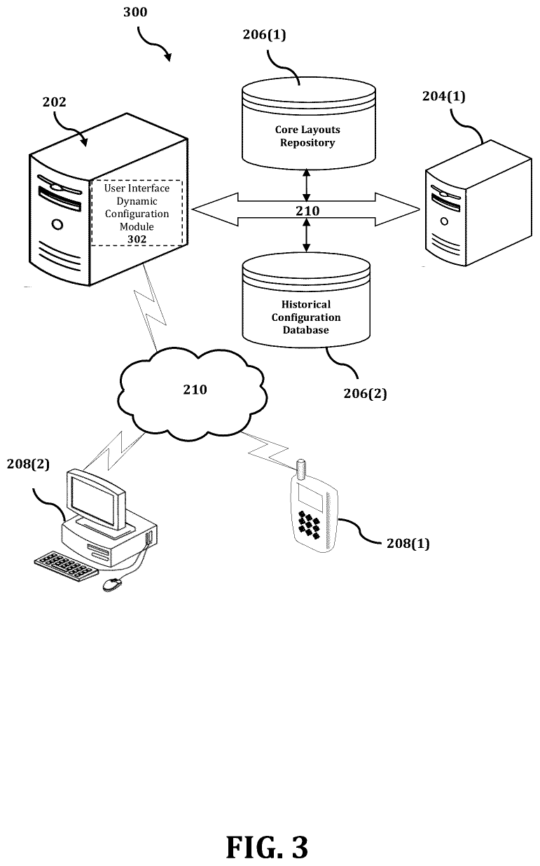

The UIDC device 202 is described and shown in FIG. 3 as including a user interface dynamic configuration module 302, although it may include other rules, policies, modules, databases, or applications, for example. As will be described below, the user interface dynamic configuration module 302 is configured to implement a method for providing an intelligent end-to-end platform to facilitate dynamic user interface configuration and customizable data storage.

An exemplary process 300 for implementing a mechanism for providing an intelligent end-to-end platform to facilitate dynamic user interface configuration and customizable data storage by utilizing the network environment of FIG. 2 is shown as being executed in FIG. 3. Specifically, a first client device 208(1) and a second client device 208(2) are illustrated as being in communication with UIDC device 202. In this regard, the first client device 208(1) and the second client device 208(2) may be “clients” of the UIDC device 202 and are described herein as such. Nevertheless, it is to be known and understood that the first client device 208(1) and/or the second client device 208(2) need not necessarily be “clients” of the UIDC device 202, or any entity described in association therewith herein. Any additional or alternative relationship may exist between either or both of the first client device 208(1) and the second client device 208(2) and the UIDC device 202, or no relationship may exist.

Further, UIDC device 202 is illustrated as being able to access a core layouts repository 206(1) and a historical configuration database 206(2). The user interface dynamic configuration module 302 may be configured to access these databases for implementing a method for providing an intelligent end-to-end platform to facilitate dynamic user interface configuration and customizable data storage.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the UIDC device 202 via broadband or cellular communication. Of course, these embodiments are merely exemplary and are not limiting or exhaustive.

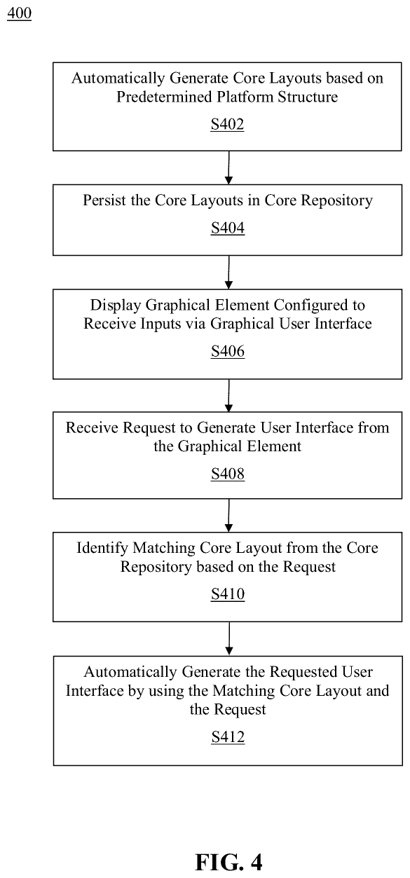

Upon being started, the user interface dynamic configuration module 302 executes a process for providing an intelligent end-to-end platform to facilitate dynamic user interface configuration and customizable data storage. An exemplary process for providing an intelligent end-to-end platform to facilitate dynamic user interface configuration and customizable data storage is generally indicated at flowchart 400 in FIG. 4.

In the process 400 of FIG. 4, at step S402, a plurality of core layouts may be automatically generated. The plurality of core layouts may be automatically generated based on a predetermined platform structure. In an exemplary embodiment, each of the plurality of core layouts may correspond to an executable microapp. The plurality of core layouts may relate to a full blown, runnable microapp that can be built with configurations that are explicitly defined with a set of contracts. For example, the plurality of core layouts may serve as templates that may be customized for execution by using the configurations. Consistent with present disclosures, the plurality of core layouts may be referenced as layout and interaction widgets (LIWs) that are created on the core repository.

In another exemplary embodiment, to automatically generate the plurality of core layouts, code libraries that correspond to the predetermined platform structure may be identified. Similarly, interactions that correspond to the predetermined platform structure may be identified. Dependencies that correspond to the predetermined platform structure may also be identified. Then, each of the plurality of core layouts may be automatically generated based on the code libraries, the interactions, and the dependencies. For example, a grid component that corresponds to a core layout may be generated according to an end-to-end framework to include needed libraries and interactions that are ready for execution. A configuration module may be plugged into the grid component to activate all associated features.

In another exemplary embodiment, the predetermined platform structure may correspond to a configurable end-to-end framework that is operable within a computing environment such as, for example, a financial post trading environment. The predetermined platform structure may relate to backend services such as, for example, auxiliary services that represent relationships between a plurality of components such as, for example, a data manager and a user action workflow service within the computing environment. For example, the auxiliary services may represent dependencies between each of the plurality of components. That is, the predetermined platform structure outlines necessary arrangement of backend services to facilitate functionalities of the plurality of core layouts.

In another exemplary embodiment, the microapp may relate to a specialized application that is designed to perform one task and/or one use case. The microapp may be configured to perform custom and specific tasks without having to enter a monolithic application. In another exemplary embodiment, the microapp may include an authentication layer, a data manipulation interface, and a notification layer. The authentication layer may be plugged into an identity and access management service provider to facilitate validation services. The data manipulation interface may interact with a data source such as, for example, a database and a corresponding application programming interface to facilitate create functions, read functions, update functions, and delete functions. The notification layer may alert one or more members of a designated development team whenever a predetermined criterion has been met.

At step S404, the plurality of core layouts may be persisted in a core repository. In an exemplary embodiment, persistence of the plurality of core layouts in the core repository may facilitate a modelized solution that captures the layouts as well as the interactions in the form of LIW templates for the user interface components. Implementation of the core repository may provide a simplified storage solution by creating common visualization data models that are maintained in a centralized location.

In another exemplary embodiment, the core repository may correspond to an organized collection of structured information such as, for example, a database that is stored electronically in a computer system. The database may relate to an organized collection of data that may be electronically stored and accessed. The database may be stored on any computing system such as, for example, a file system, a clustered computing system, and/or a cloud storage system.

At step S406, graphical elements that are configured to receive user inputs may be displayed. The graphical elements may be displayed via a graphical user interface. In an exemplary embodiment, the graphical elements that are displayed via the graphical user interface may represent a frontend component of the configurable end-to-end framework consistent with present disclosures. The frontend component may be expressed as a rendering function that accepts attributes and produces a visual representation to the user. The frontend component may relate to a presentation layer of the configurable end-to-end framework.

In another exemplary embodiment, the graphical elements may include any combination of shapes, symbols, and words that may be configured together to receive user inputs. The graphical elements may also include backgrounds and graphical illustrations that together provide a cohesive experience for the user. For example, the graphical elements may include interactive toggles, buttons, and blocks that a developer may interact with on a build screen to combine various business logics, together to design a desired user interface. In another exemplary embodiment, the graphical user interface may allow users to interact with electronic devices through graphical icons such as, for example, the graphical elements. The graphical user interface may include windows, icons, and menus that are usable to carry out commands such as, for example, opening, deleting, and moving files. Consistent with present disclosures, the graphical user interface may allow users such as, for example, developers to interact with the disclosed invention, while the user interface may relate to an output of the disclosed invention that is desired by the developers.

At step S408, requests to generate a user interface may be received via the graphical user interface. In an exemplary embodiment, the request may include a selection of at least one from among a rule, a business logic, and a service. The selection may be received as user inputs on the graphical user interface. For example, a user such as a developer may interact with the graphical user interface via input devices such as a mouse and keyboard to select at least one from among the rule, the business logic, and the service.

In another exemplary embodiment, the rule may relate to a set of explicit regulations and/or principles that govern conduct within the configurable end-to-end framework. For example, the rule may be selected by a line of business to dictate how various components such as storage components may interact. In another exemplary embodiment, the business logic may relate to a domain logic that represents an encoding of real-world business rules. The business logic may determine how data is created, stored, and changed within the configurable end-to-end framework. For example, the business logic may determine how long customer data may be persisted within a storage component. In another exemplary embodiment, the service may relate to a software that performs automated tasks, responds to hardware events, and/or listens for data requests from other software within the configurable end-to-end framework. The services may be loaded automatically and run without user interaction.

In another exemplary embodiment, to receive the request, user actions that correspond to the selection may be received via the graphical user interface. The user actions may include a drag and drop action to select at least one from among the rule, the business logic, and the service. For example, a developer may drag and drop rules, business logics, and services on a build screen to effectuate the selection. In another exemplary embodiment, the user actions may be usable to organize the selection by combining the rule, the business logic, and the service. For example, the developer may drag and drop the rules, the business logics, and the services on the build screen to form various combinations to achieve a desired function. That is, the function depends on the specific combination as organized by the developer.

In another exemplary embodiment the user interface may relate to a graphical user interface that is desired by a line of business. The user interface may allow users to interact with electronic devices through graphical icons. The user interface may include windows, icons, and menus that are usable to carry out commands such as, for example, opening, deleting, and moving files. In the present disclosure, a distinction is made between a graphical user interface and the user interface that is desired and requested by the line of business. Consistent with present disclosures, the graphical user interface may allow users such as, for example, developers to interact with the disclosed invention, while the user interface may relate to an output of the disclosed invention that is desired by the developers.

At step S410, matching core layouts may be identified based on the request. The matching core layouts may be identified from the plurality of core layouts in the core repository. In an exemplary embodiment, the request may be parsed to discover the selected rules, business logics, and services. The matching core layouts may be identified based on the discovered rules, business logics, and services. The matching core layout may be identified to facilitate the functionalities required based on the selected rules, business logics, and services. For example, the matching core layout may be identified because it facilitates the functionalities required by the line of business based on the selections made by the line of business.

At step S412, the requested user interface may be automatically generated by using the matching core layouts and the request. In an exemplary embodiment, to automatically generate the requested user interface, configurations may be extracted from the request. The configurations may correspond to desired arrangements for the requested user interface. A configuration component for each of the matching core layouts may be generated based on the extracted configurations. Then, the requested user interface may be automatically generated by combining the matching core layouts with the corresponding configuration component.

In another exemplary embodiment, the configuration component may include a configuration module that represents a set of configurations. The configuration module may be passed to replace the placeholders in the matching core layout. Additionally, an application module may expect the set of configurations from the configuration module. Consistent with present disclosures, the application module may facilitate deployment for the line of business by combining the matching core layout and the configuration module.

In another exemplary embodiment, configuration data that correspond to the requested user interface may be aggregated. The configuration data may include information that relates to at least one from among the request, the matching core layouts, and the requested user interface. The configuration data may be associated with a line of business by using identifying data that is extracted from the request. For example, an identifier that corresponds to the line of business may be extracted from the request and may be usable to associate the requested user interface with the line of business. Then, the configuration data and the association may be persisted in a historical configuration database.

In another exemplary embodiment, suggested configurations may be determined by using a model. The suggested configurations may be determined for the line of business based on the corresponding configuration data in the historical configuration database. For example, the model may use historical configuration data that have been associated with the line of business to predict configurations that may be requested by the line of business.

The predicted configurations may be presented as suggested configurations for the line of business. For example, the suggested configurations may be presented for selection by the line of business to quickly generate the requested user interface without requiring repetitive inputs from the line of business. The suggested configurations may be displayed in the graphical element for the line of business. Consistent with present disclosures, the graphical element may be viewable by the line of business via the graphical user interface.

In another exemplary embodiment, the model may include at least one from among a machine learning model, a mathematical model, a process model, and a data model. The model may also include stochastic models such as, for example, a Markov model that is used to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, logistic regression analysis, etc. In another exemplary embodiment, machine learning analytical techniques may include unsupervised learning algorithms such as, for example, Apriori algorithm analysis, K-means clustering analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

In another exemplary embodiment, user profile data and corresponding search history data may be captured. The user profile data and the corresponding search history data may be captured via the automatically generated/requested user interface. Then, predicted data sets for a user may be determined by using the model. The predicted data sets may be determined based on the user profile data and the corresponding search history data. The predicted data sets may be preloaded in a temporary quick access repository for the user.

In another exemplary embodiment, the predicted data sets may be automatically archived by using the model. The predicted data sets may be automatically archived based on the user profile data and the corresponding search history data. The predicted data sets may be automatically archived at a time that is determined by using the model.

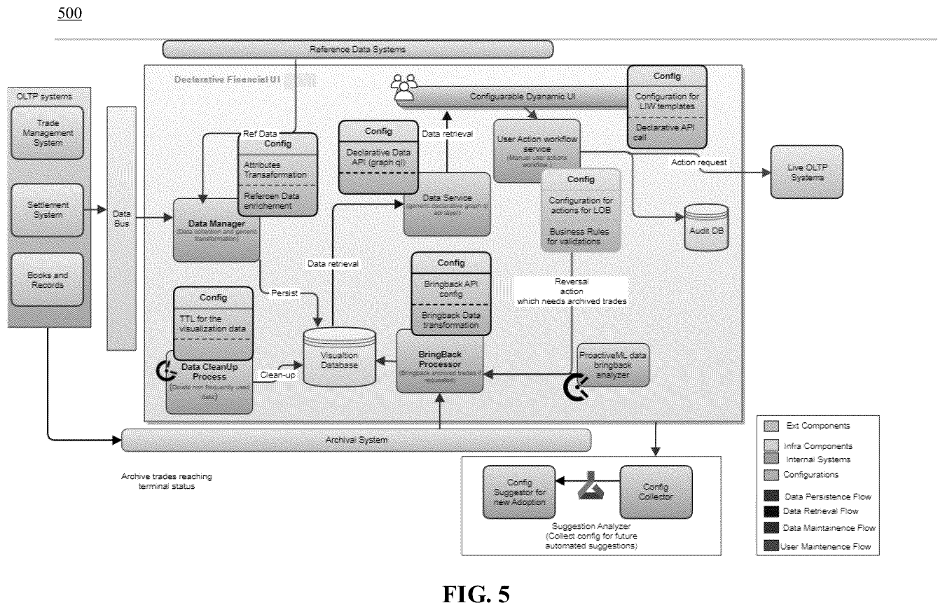

FIG. 5 is a flow diagram 500 of an exemplary process for implementing a method for providing an intelligent end-to-end platform to facilitate dynamic user interface configuration and customizable data storage. In FIG. 5, a platform is provided that can identify line of business functional logics, associate, and load the frontend with the corresponding logics in a required format. The platform may relate to the configurable end-to-end framework described in the present disclosure.

In another exemplary embodiment, the platform may enable a robust and easily configurable framework for each layer such that lines of businesses may easily create tailored versions of applications and user interfaces with desired rules and business logic. The platform may include a modelized solution that captures the layout as well as the interaction in the form of core layouts for user interface components. Similarly, the platform may include simplified storage that creates common visualization data models that are maintained in a centralized place. The platform may segregate the visualization requirements, which tends to be more common, from processing systems such as, for example, an online transactional processing system, which tends to be more specific. The platform may represent an intelligent, dynamically identifiable source system, and configurable data persistence layer that supports the visualization requirements and avoids data duplications.

As illustrated in FIG. 5, consistent with present disclosures, the platform may include a dynamic user interface component, a core actions library, an intelligent bring back service, a data manager, and a data service. The platform may provide a centralized maintenance solution for code frameworks that will ensure the latest libraries and features are kept up to date. Lines of businesses will only need to work with business configurations that matter the most to effectuate desired changes. The centralized user interface core layouts may mean that the workflows and interactions remain consistent across lines of businesses. The centralized solution may reduce code duplications which also reduces code maintenance.

In another exemplary embodiment, by keeping dedicated visualization data, data indexing of the visualization data may be tailored without impacting the processing system databases. Overall performance may be enhanced by reducing the impact to the processing system databases. Additionally, operation training and learning curves for the lines of businesses would be reduced considerably since each of the lines of businesses would be dealing with similar interaction patterns and concepts across the board for corresponding systems such as, for example, a financial system.

In another exemplary embodiment, consistent with present disclosures, the dynamic user interface component may enable a line of business to quickly and easily build desired user interfaces based on core layouts such as, for example, microapp templates. The core actions library may relate to a configurable workflow that will power each of the action library jars inside the core repository. The action library jars may be plugged together in a line of business repository to create line of business runner action services.

In another exemplary embodiment, the intelligent bring back service may gauge user profiles and corresponding search patterns to proactively bring back data such as, for example, trade data at a predetermined time such as, for example, at the start of the day. This will ensure that the bulk of the data is already brought back and ready to facilitate the user search. Consistent with present disclosures, a machine learning model may be usable to ensure that the data is archived at an appropriate time when the data is no longer required by the user.

In another exemplary embodiment, the data manager may be responsible for collecting the data from a system of record and data lakes. The data manager may transform and enrich the data for storage on various collections to serve internal user interface requirements and external user interface requirements. In another exemplary embodiment, the data service may provide enriched data to external services as well as to internal user interface widgets. Personalized configurations may be required for each line of business to select applicable data attributes.

Accordingly, with this technology, an optimized process for providing an intelligent end-to-end platform to facilitate dynamic user interface configuration and customizable data storage is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for providing an intelligent end-to-end platform to facilitate dynamic user interface configuration, the method being implemented by at least one processor, the method comprising:
automatically generating, by the at least one processor, a plurality of core layouts based on a predetermined platform structure, each of the plurality of core layouts corresponding to an executable microapp;
persisting, by the at least one processor, the plurality of core layouts in a core repository;
displaying, by the at least one processor via a graphical user interface, at least one graphical element that is configured to receive at least one input;
receiving, by the at least one processor via the graphical user interface, a request to generate at least one user interface, the request including a selection of at least one from among a rule, a business logic, and a service;
identifying, by the at least one processor based on the request, at least one matching core layout from the plurality of core layouts in the core repository; and
automatically generating, by the at least one processor, the at least one user interface by using the at least one matching core layout and the request.

2. The method of claim 1, further comprising:
aggregating, by the at least one processor, configuration data that correspond to the at least one user interface, the configuration data including information that relates to at least one from among the request, the at least one matching core layout, and the at least one user interface;
associating, by the at least one processor, the configuration data with a line of business by using identifying data that is extracted from the request; and
persisting, by the at least one processor, the configuration data and the association in a historical configuration database.

3. The method of claim 2, further comprising:
determining, by the at least one processor using at least one model, at least one suggested configuration for the line of business based on the corresponding configuration data in the historical configuration database; and
displaying, by the at least one processor via the graphical user interface, the at least one suggested configuration in the at least one graphical element for the line of business.

4. The method of claim 3, wherein the at least one model includes at least one from among a machine learning model, a mathematical model, a process model, and a data model.

5. The method of claim 1, wherein automatically generating the plurality of core layouts further comprises:
identifying, by the at least one processor, at least one code library that corresponds to the predetermined platform structure;
identifying, by the at least one processor, at least one interaction that corresponds to the predetermined platform structure;
identifying, by the at least one processor, at least one dependency that corresponds to the predetermined platform structure; and
automatically generating, by the at least one processor, each of the plurality of core layouts based on the at least one code library, the at least one interaction, and the at least one dependency.

6. The method of claim 1, wherein receiving the request further comprises:
receiving, by the at least one processor via the graphical user interface, at least one user action that corresponds to the selection,
wherein the at least one user action includes a drag and drop action to select at least one from among the rule, the business logic, and the service.

7. The method of claim 1, wherein automatically generating the at least one user interface further comprises:
extracting, by the at least one processor, at least one configuration from the request, the at least one configuration corresponding to the at least one user interface;
generating, by the at least one processor, a configuration component for each of the at least one matching core layout based on the extracted at least one configuration; and
automatically generating, by the at least one processor, the at least one user interface by combining the at least one matching core layout with the corresponding configuration component.

8. The method of claim 1, further comprising:
capturing, by the at least one processor via the automatically generated at least one user interface, user profile data and corresponding search history data;
determining, by the at least one processor using at least one model, at least one predicted data set for a user based on the user profile data and the corresponding search history data; and
preloading, by the at least one processor, the at least one predicted data set in a temporary quick access repository for the user.

9. The method of claim 8, further comprising:
automatically archiving, by the at least one processor using the at least one model, the at least one predicted data set based on the user profile data and the corresponding search history data,
wherein the at least one predicted data set is automatically archived at a time determined by using the at least one model.

10. A computing device configured to implement an execution of a method for providing an intelligent end-to-end platform to facilitate dynamic user interface configuration, the computing device comprising:
a processor;
a memory; and
a communication interface coupled to each of the processor and the memory,
wherein the processor is configured to:
automatically generate a plurality of core layouts based on a predetermined platform structure, each of the plurality of core layouts corresponding to an executable microapp;
persist the plurality of core layouts in a core repository;
display, via a graphical user interface, at least one graphical element that is configured to receive at least one input;
receive, via the graphical user interface, a request to generate at least one user interface, the request including a selection of at least one from among a rule, a business logic, and a service;
identify, based on the request, at least one matching core layout from the plurality of core layouts in the core repository; and
automatically generate the at least one user interface by using the at least one matching core layout and the request.

11. The computing device of claim 10, wherein the processor is further configured to:
aggregate configuration data that correspond to the at least one user interface, the configuration data including information that relates to at least one from among the request, the at least one matching core layout, and the at least one user interface;
associate the configuration data with a line of business by using identifying data that is extracted from the request; and
persist the configuration data and the association in a historical configuration database.

12. The computing device of claim 11, wherein the processor is further configured to:
determine, by using at least one model, at least one suggested configuration for the line of business based on the corresponding configuration data in the historical configuration database; and
display, via the graphical user interface, the at least one suggested configuration in the at least one graphical element for the line of business.

13. The computing device of claim 12, wherein the at least one model includes at least one from among a machine learning model, a mathematical model, a process model, and a data model.

14. The computing device of claim 10, wherein, to automatically generate the plurality of core layouts, the processor is further configured to:
identify at least one code library that corresponds to the predetermined platform structure;
identify at least one interaction that corresponds to the predetermined platform structure;
identify at least one dependency that corresponds to the predetermined platform structure; and
automatically generate each of the plurality of core layouts based on the at least one code library, the at least one interaction, and the at least one dependency.

15. The computing device of claim 10, wherein, to receive the request, the processor is further configured to:
receive, via the graphical user interface, at least one user action that corresponds to the selection,
wherein the at least one user action includes a drag and drop action to select at least one from among the rule, the business logic, and the service.

16. The computing device of claim 10, wherein, to automatically generate the at least one user interface, the processor is further configured to:
extract at least one configuration from the request, the at least one configuration corresponding to the at least one user interface;
generate a configuration component for each of the at least one matching core layout based on the extracted at least one configuration; and
automatically generate the at least one user interface by combining the at least one matching core layout with the corresponding configuration component.

17. The computing device of claim 10, wherein the processor is further configured to:
capture, via the automatically generated at least one user interface, user profile data and corresponding search history data;
determine, by using at least one model, at least one predicted data set for a user based on the user profile data and the corresponding search history data; and
preload the at least one predicted data set in a temporary quick access repository for the user.

18. The computing device of claim 17, wherein the processor is further configured to:
automatically archive, by using the at least one model, the at least one predicted data set based on the user profile data and the corresponding search history data, wherein the at least one predicted data set is automatically archived at a time determined by using the at least one model.

19. A non-transitory computer readable storage medium storing instructions for providing an intelligent end-to-end platform to facilitate dynamic user interface configuration, the storage medium comprising executable code which, when executed by a processor, causes the processor to:
automatically generate a plurality of core layouts based on a predetermined platform structure, each of the plurality of core layouts corresponding to an executable microapp;
persist the plurality of core layouts in a core repository;
display, via a graphical user interface, at least one graphical element that is configured to receive at least one input;
receive, via the graphical user interface, a request to generate at least one user interface, the request including a selection of at least one from among a rule, a business logic, and a service;
identify, based on the request, at least one matching core layout from the plurality of core layouts in the core repository; and
automatically generate the at least one user interface by using the at least one matching core layout and the request.

20. The storage medium of claim 19, wherein, when executed by the processor, the executable code further causes the processor to:
aggregate configuration data that correspond to the at least one user interface, the configuration data including information that relates to at least one from among the request, the at least one matching core layout, and the at least one user interface;
associate the configuration data with a line of business by using identifying data that is extracted from the request; and
persist the configuration data and the association in a historical configuration database.
